(19) United States
(12) Patent Application Publication
(10) Pub. No.: US 2011/0096224 A1
(43) Pub. Date: Apr. 28, 2011

(54) Camera module package

(75) Inventor: Sang Yeun Lee, Suwon (KR)

(73) Assignee: SAMSUNG ELECTRO-MECHANICS CO., LTD., Suwon (KR)

(21) Appl. No.: 12/801,950

(22) Filed: Jul. 2, 2010

(30) Foreign Application Priority Data
Oct. 23, 2009 (KR) 10-2009-0101034

(51) Int. Cl. H04N 5/225

(52) U.S. Cl. 348/374; 348/E05.025

(57) ABSTRACT

There is provided a camera module package including: a lens barrel having a lens deposited therein; a housing having the lens barrel installed therein; a board bonded to the housing and having an image sensor provided on one surface thereof to coincide with an optical axis of the lens; and a shield can covering the outside of the housing and having a ground portion. The ground portion is protruded outwards from an outer side surface of the shield can and contacts an inner side surface of a socket when the shield can is inserted into the socket.

### CROSS-REFERENCE TO RELATED APPLICATIONS

This application claims the priority of Korean Patent Application No. 10-2009-0101034 filed on Oct. 23, 2009, in the Korean Intellectual Property Office, the disclosure of which is incorporated herein by reference.

### BACKGROUND OF THE INVENTION

1. Field of the Invention

The present invention relates to a camera module, and more particularly, to a camera module package with an image pickup function, which is installed in a personal portable terminal or the like.

2. Description of the Related Art

With the development of communication technologies and digital information processing technologies, new technologies for potable terminals integrating a variety of functions, such as information processing, calculation, communication, and image information input and output, are on the rise.

Specifically, a personal digital assistant (PDA) having a digital camera function and a communication function, a mobile phone having a digital camera function, and a personal multi-media player (PMP) may be provided as examples.

Also, due to the enhancement of digital camera technologies and information storage capability, installing a high-performance digital camera module package in a personal portable terminal is becoming common.

Recently, a personal portable terminal is increasingly slimed and thinned according to consumers' preferences. In line with this trend, a camera module package installed in the personal portable terminal is also getting smaller.

A conventional camera module may be installed with electronic components such as an image sensor or a shield case for shielding against electromagnetic interference (EMI) with respect to electronic signals output from the image sensor.

Here, the shield case and a board are joined with solder for ground connection.

However, during the soldering operation, it is difficult to join small pieces of components with solder in a small and narrow space. Also, since the shield case formed of a conductive material has high thermal conductivity, the solder does not easily adhere thereto and the amount of solder is not easily controlled. Further, the soldering is a reasonably time-consuming process. Therefore, there is a need for technologies in order to solve those problems.

### SUMMARY OF THE INVENTION

An aspect of the present invention provides a camera module package that does not require a ground connection between a board and a shield can by soldering.

According to an aspect of the present invention, there is provided a camera module package including: a lens barrel having a lens deposited therein; a housing having the lens barrel installed therein; a board bonded to the housing and having an image sensor provided on one surface thereof to coincide with an optical axis of the lens; and a shield can covering the outside of the housing and having a ground portion. The ground portion is protruded outwards from an outer side surface of the shield can and contacts an inner side surface of a socket when the shield can is inserted into the socket.

The socket may have a fixing piece formed by being protruded from the inner side surface of the socket in order to put the housing into an inner space of the socket, and the fixing piece may be positioned so as to correspond to the ground portion of the shield can.

The shield can may have a hexahedral shape including an open bottom and the ground portion may include a plurality of ground portions formed on four side surfaces of the shield can.

The board may have a ground pad portion on a side surface thereof.

The board may have a ground pad portion on a bottom surface thereof.

The shield can may have a fixing groove with which to be coupled with the housing to fix a position of the housing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a camera module package according to an exemplary embodiment of the present invention;

FIG. 2 is an assembled perspective view illustrating the camera module package of FIG. 1 in which a housing and a shield can are assembled within a socket;

FIG. 3 is a cross-sectional view illustrating a socket of a camera module package according to an exemplary embodiment of the present invention;

FIG. 4 is a cross-sectional view illustrating a shield can installed in the socket of FIG. 3; and

FIG. 5 is a perspective view illustrating a camera module package according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

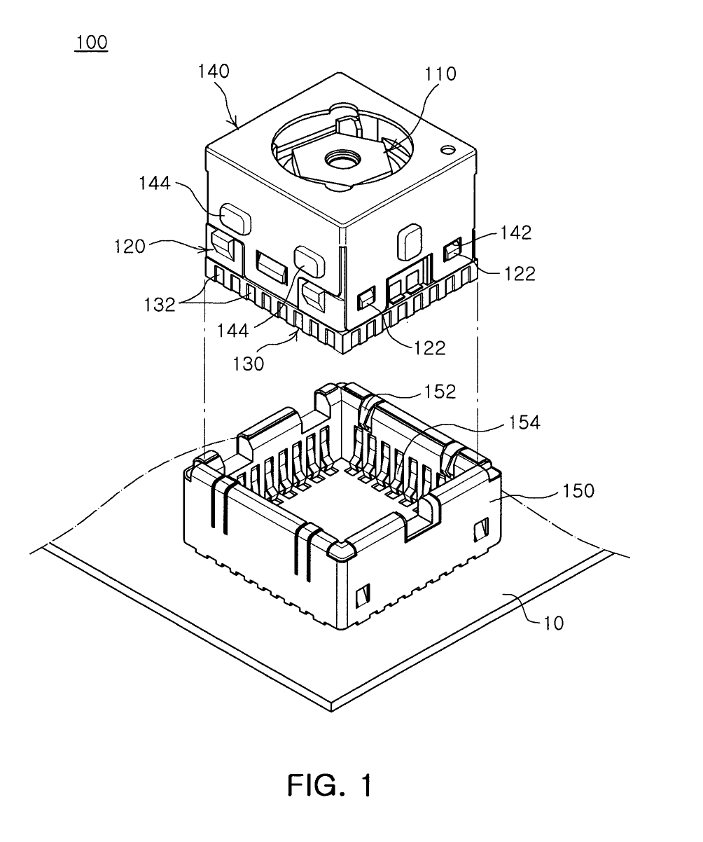

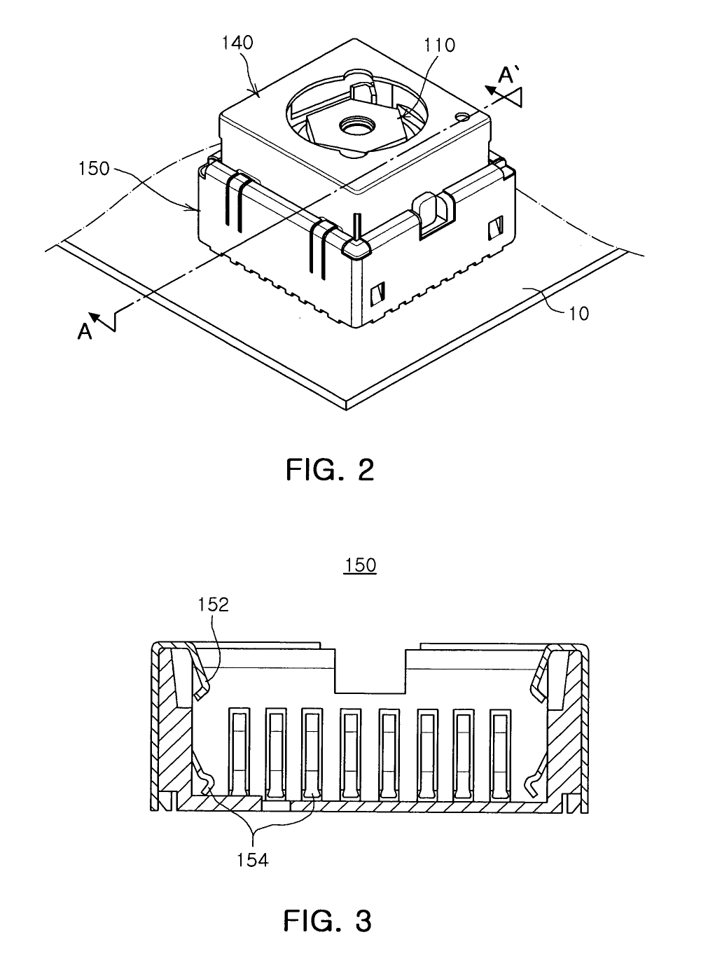

FIG. 1 is an exploded perspective view illustrating a camera module package according to an exemplary embodiment of the present invention. FIG. 2 is an assembled perspective view illustrating the camera module package of FIG. 1 in which a housing and a shield can are assembled within a socket.

Referring to FIGS. 1 and 2, a camera module package 100 includes a lens barrel 110, a housing 120, and a board 130.

The lens barrel 110 may have an inner space of a predetermined size, in which one or more lenses are arrayed along an optical axis. The lens barrel 110 may have a center hole and a cylindrical shape. Also, the lens barrel 110 may have a lens hole perforated in the top surface thereof in order to transmit light.

Although not shown in detail, the lens barrel 110 according to this embodiment may have at least one spacer installed therein, in order to have a uniform space between adjacent lenses. However, the number of lenses deposited in the lens barrel 110 is not limited. At least one lens can be deposited in the lens barrel 110.

In addition, an actuator (not shown) may be provided adjacent to the lens barrel 110. When power is applied, the actuator allows the lens to be reciprocally movable in an optical axis direction.

The actuator may be realized in a variety of types, such as a voice coil motor (VCM) actuator and a piezo actuator. The VCM actuator uses a magnet and a coil in such a manner that the VCM actuator allows for the movement of a lens by electromagnetic force generated while an electric field generated by applying power to the coil is interlinked with a magnetic field generated from the magnet. The piezo actuator uses piezoelectric materials in such a manner that the piezo actuator allows for the movement of a lens by transforming the piezoelectric materials when power is applied.

The housing 120 has the lens barrel 110 disposed therein in such a manner that one surface of the lens barrel 110 is exposed to the outside. The housing 120 has an open bottom to which the board 130 is bonded, so that the housing 120 and the board 130 are fixed to each other. Accordingly, the housing 120 is able to act as a frame accommodating the lens barrel 110 and serve to protect internal elements from the outside.

Here, although not indispensable, an infrared (IR) filter may be bonded to the inside of the housing 120 to filter infrared rays from the light passing through the lens.

The board 130 may be bonded to one surface of the housing 120 by an adhesive to be thereby fixed thereto. The board 130 may have an image sensor mounted on the top surface thereof to coincide with the optical axis direction of the lens.

Here, the image sensor is an imaging device having an imaging area formed on the top surface thereof to image light incident through the lens and output the imaged light as an electrical signal.

Also, the board 130 has a ground pad portion 132 formed on the side surface thereof in order that a camera module can be electrically connected to the socket 150 when installed in the socket 150 mounted on a main board 10.

Therefore, the socket 150 has a ground piece 154 protruded from the inner side surface of the socket 150 in order that the socket 150 can be electrically connected to a ground portion 144. This electrical connection leads to an electrical connection with the main board 10.

A shield can 140 may cover the outside of the housing 120 and have an opening in one surface thereof to expose the lens barrel 110 of the housing 120. Also, the shield can 140 has the housing 120 disposed therein in order to shield the image sensor from electromagnetic interference (EMI). Further, the shield can 140 may be formed of metal.

The shield can 140 has a coupling groove 142 provided on the side surface thereof, so that the coupling groove 142 may be coupled with a coupling portion 122 of the housing 120 to fix each other.

Also, the shield can 140 may have the ground portion 144 protruding outwards from the side surface thereof. Such a protruding ground portion 144 may be integrally formed with the shield can 140 by bending the shield can 140 itself outwards.

Further, there may be provided a plurality of ground portions 144. The shield can 140 of a hexahedral shape may have the plurality of ground portions 144 positioned on the four side surfaces thereof in such a manner that the plurality of ground portions 144 correspond to fixing pieces 152 formed in the inside of the socket 150.

Here, when the shield can 140 is installed in the socket 150, the fixing pieces 152 and the ground portions 144 are automatically in contact with each other and are grounded to each other.

Since the camera module package 100 according to this embodiment includes the ground portion 144 formed by being protruded outwards from the outer side surface of the shield can 140 and grounded by being inserted into the socket 150, the socket 150 and the ground portion 144 automatically contact each other when the housing 120 is inserted into the socket 150. Accordingly, there is no need to carry out an additional operation for grounding. In this regard, the solder paste soldering operation of the shield can 140 can be omitted, whereby the manufacturing process is simplified and the processing time is reduced.

Here, the socket 150 may be fixed to the main board 10 of a personal portable terminal. The socket 150 may have an inner space into which the housing 120 is inserted. The socket 150 may be mounted on the main board 10 by an automatic process, thereby more easily facilitating the process.

Generally, in order to mount a camera module package in a personal portable terminal, a socket or a connector may be used.

A method of mounting a camera module package using a socket is used for electrical connection in such a manner that the socket having a camera module therein is mounted on a main board of a personal portable terminal. This method has a great effect of preventing electromagnetic interference (EMI) and facilitates an automated package construction process.

Also, in order to manufacture the camera module package, the camera module is merely required to be installed in the socket that is previously mounted on the main board. This facilitated automatic process leads to a reduction in manufacturing costs.

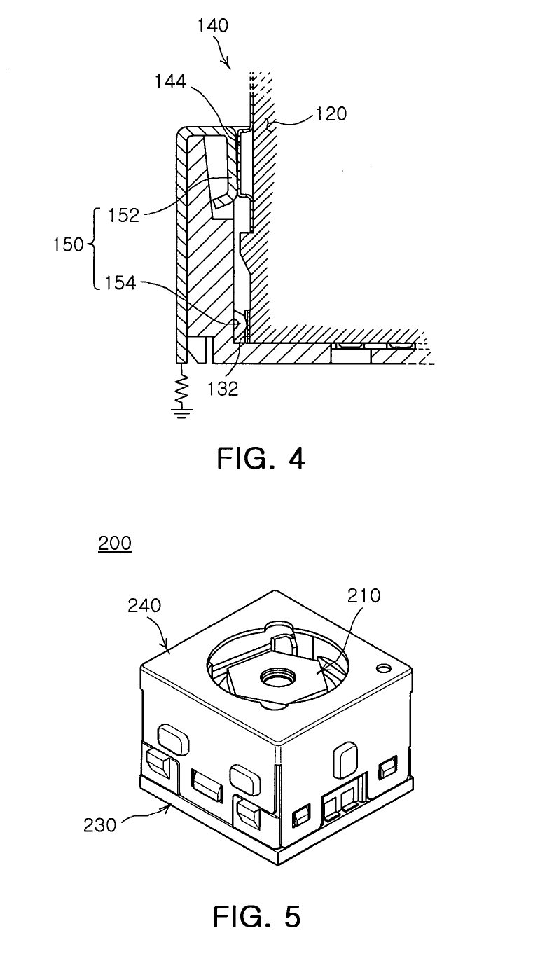

FIG. 3 is a cross-sectional view illustrating a socket of a camera module package according to an exemplary embodiment of the present invention. FIG. 4 is a cross-sectional view illustrating a shield can installed in the socket of FIG. 3.

Referring to FIGS. 3 and 4, the socket 150 may have the ground piece 154 disposed therein. The ground piece 154 has elastic force in order to be movable inwards. The ground piece 154 is formed by being bent inwards.

At this time, the socket 150 is formed by an automatic process to be fixed to the main board. The housing 120 coupled with the shield can 140 is inserted through an open top of the socket 150.

Accordingly, as shown in FIG. 4, the housing 120 may be disposed in the inner space of the socket 150.

At this time, the socket 150 has the fixing piece 152 in order to fix the position of the housing 120. When the housing 120 coupled with the shield can 140 is inserted into the socket 150, the ground portion 144 protruded outwards from the shield can 140 and the fixing piece 152 are automatically in contact with each other.

Here, since the fixing piece 152 is connected to an external ground, the shield can 140 is automatically grounded by the ground portion 144 that is in contact with the fixing piece 152.

In the case that such a ground portion is not included, an additional soldering operation is required. According to this embodiment, however, the solder paste soldering operation of the shield can 140 can be omitted due to the ground portion 144, and thus the process is simplified and the required processing time is reduced.

FIG. 5 is a perspective view illustrating a camera module package according to another exemplary embodiment of the present invention.

Referring to FIG. 5, a camera module package 200 includes a lens barrel 210, a housing 220, a board 230 and a shield can 240.

Here, the lens barrel 210, the housing 220, and the shield can 240 according to this embodiment are substantially identical to those according to the aforementioned embodiment in terms of constitution, so a detailed description thereof will therefore be omitted.

The board 230 has a ground pad portion on the bottom surface thereof. When the board 230 is inserted into a socket, this ground pad portion is electrically connected to a ground piece formed on the bottom surface of the socket. Therefore, when the board 230 in contact with the housing 220 is inserted into the socket, electrical connection is automatically made between them.

As set forth above, according to exemplary embodiments of the invention, a camera module package includes a ground portion formed by being protruded outwards from the outer side surface of a shield can and grounded by being inserted into an external socket, and accordingly, when a housing is inserted into the socket, the socket and the ground portion automatically contact each other. That is, there is no need to carry out an additional operation for grounding. Therefore, the solder paste soldering operation of the shield can is omitted, and the process is thus simplified and the processing time is reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A camera module package comprising:
a lens barrel having a lens deposited therein;
a housing having the lens barrel installed therein;
a board bonded to the housing and having an image sensor provided on one surface thereof to coincide with an optical axis of the lens; and
a shield can covering the outside of the housing and having a ground portion, the ground portion being protruded outwards from an outer side surface of the shield can and contacting an inner side surface of a socket when the shield can is inserted into the socket.

2. The camera module package of claim 1, wherein the socket has a fixing piece formed by being protruded from the inner side surface of the socket in order to put the housing into an inner space of the socket, and the fixing piece is positioned so as to correspond to the ground portion of the shield can.

3. The camera module package of claim 1, wherein the shield can has a hexahedral shape including an open bottom and the ground portion comprises a plurality of ground portions formed on four side surfaces of the shield can.

4. The camera module package of claim 1, wherein the board has a ground pad portion on a side surface thereof.

5. The camera module package of claim 1, wherein the board has a ground pad portion on a bottom surface thereof.

6. The camera module package of claim 1, wherein the shield can has a fixing groove with which to be coupled with the housing to fix a position of the housing.
